(19) United States
(12) Patent Application Publication
(10) Pub. No.: US 2018/0012284 A1
(43) Pub. Date: Jan. 11, 2018

(54) INFORMATION ANALYSIS APPARATUS, INFORMATION ANALYSIS METHOD, AND NON-TRANSITORY COMPUTER READABLE STORAGE MEDIUM

(71) Applicant: YAHOO JAPAN CORPORATION, Tokyo (JP)

(72) Inventors: Ryo IGARASHI, Tokyo (JP); Yotaro SUZUKI, Tokyo (JP); Kenji IMAI, Tokyo (JP); Yuki SAITO, Tokyo (JP)

(73) Assignee: YAHOO JAPAN CORPORATION, Tokyo (JP)

(21) Appl. No.: 15/636,481

(22) Filed: Jun. 28, 2017

(30) Foreign Application Priority Data
Jul. 5, 2016 (JP) 2016-133353

(51) Int. Cl. G06Q 30/06; G06F 7/02

(52) U.S. Cl. CPC G06Q 30/0631; G06F 7/026

(57) ABSTRACT

An information analysis apparatus includes: a weight assigning unit that assigns a weight to each of a plurality of items based on an action taken by a user who has viewed a sales content on which the plurality of items to be recommended are posted; a selection unit that selects a plurality of pairs in which two items are selected among the plurality of items placed in the sales content and associated with each other; and an evaluation unit that evaluates a characteristic based on characteristic information indicating a property of each of the two items selected as a pair by the selection unit and the weight assigned by the weight assigning unit to the two items.

### CROSS-REFERENCE TO RELATED APPLICATION(S)

The present application claims priority to and incorporates by reference the entire contents of Japanese Patent Application No. 2016-133353 filed in Japan on Jul. 5, 2016.

### BACKGROUND OF THE INVENTION

### 1. Field of the Invention

The present invention relates to an information analysis apparatus, an information analysis method, and an information analysis program.

### 2. Description of the Related Art

Conventionally, research has been conducted on a technique for displaying goods or services matching the user's hobby preference as recommendation, on a shopping site on the Internet. In this regard, by performing machine learning using click log of advertisement as learning data, a technique for predicting CTR (Click Through Rate) is known (for example, refer to JP 2014-174753 A).

In the conventional technique, by deciding which products or services to recommend by using click log data, there have been cases where goods or services that are not very interested to the user are recommended. As a result, it may be difficult to improve the purchase willingness of the user.

### SUMMARY OF THE INVENTION

It is an object of the present invention to at least partially solve the problems in the conventional technology.

According to one aspect of an embodiment, An information analysis apparatus includes a weight assigning unit that assigns a weight to each of a plurality of items based on an action taken by a user who has viewed a sales content on which the plurality of items to be recommended are posted. The information analysis apparatus includes a selection unit that selects a plurality of pairs in which two items are selected among the plurality of items placed in the sales content and associated with each other. The information analysis apparatus includes an evaluation unit that evaluates a characteristic based on characteristic information indicating a property of each of the two items selected as a pair by the selection unit and the weight assigned by the weight assigning unit to the two items.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 illustrates an example of an information analysis system 1 including an information analysis apparatus 200 according to an embodiment;

FIG. 2 illustrates an example of a sales site displayed on a terminal device 10;

FIG. 3 illustrates an example of a web server device 100 according to the embodiment;

FIG. 4 illustrates an example of the information analysis apparatus 200 according to the embodiment;

FIG. 5 illustrates an example of a recommended item information 232;

FIG. 6 illustrates an example of a characteristic for each recommended item;

FIG. 7 illustrates an example of item-by-item label information 234;

FIG. 8 illustrates an example of a feature space;

FIG. 9 illustrates an example of a flow of processing by the information analysis apparatus 200 according to the present embodiment;

FIG. 10 illustrates an example of acquisition period of data used for verification of an evaluation method;

FIG. 11 illustrates an example of a verification result in an offline;

FIG. 12 illustrates an example of a verification result in an online;

FIG. 13 illustrates another example of the verification result in an online;

FIG. 14 illustrates an example of the information analysis apparatus 200 and a machine learning apparatus 300 which is another analysis apparatus; and

FIG. 15 illustrates an example of a hardware configuration of the web server device 100 and the information analysis apparatus 200 according to the embodiment.

### DETAILED DESCRIPTION OF THE PREFERRED EMBODIMENTS

Hereinafter, an information analysis apparatus, an information analysis method, and a non-transitory computer readable storage medium having stored therein an information analysis program to which the present invention is applied will be described with reference to the drawings.

Overview

The information analysis apparatus is realized by one or more processors. The information analysis apparatus is a device that evaluates a characteristic indicating a property of a recommended item based on the action of a user who browses sales content on which a plurality of recommended items (recommended items) are displayed.

The sales content includes a website (sales site) displayed by a UA (User Agent) such as a web browser, an application screen displayed when the application program installed in the terminal device cooperates with the server, and the like. In the following description, it is assumed that the sales content is a sales site displayed by the web browser.

An item includes one or both of goods and services. An item may be displayed as an image or text (character) in a part or all of the sales site, or may be displayed by pop-uping a new window on the window displaying the sales site.

The characteristic includes a word included in an introduction text such as a title displayed when an item is posted on the sales site, attribute information such as a category previously assigned to items, and other information.

Evaluation of characteristic is performed from the viewpoint of whether the action of the user who has browsed the sales site has been guided in a preferable direction (for example, purchasing direction) when the item recommended at the sales site has its characteristic. For example, evaluation of characteristic is performed by comprehensively selecting any two recommended items (there is no need to select everything), analyzing a disparity in user's action among the selected pairs, and machine learning the result. As a result, it is possible to generate information for recommending an item with high interest of the user. By applying this evaluation result to criteria for adoption of recommended items and the like on and after the next time, it is possible to improve the sales performance of the sales site.

Overall Structure

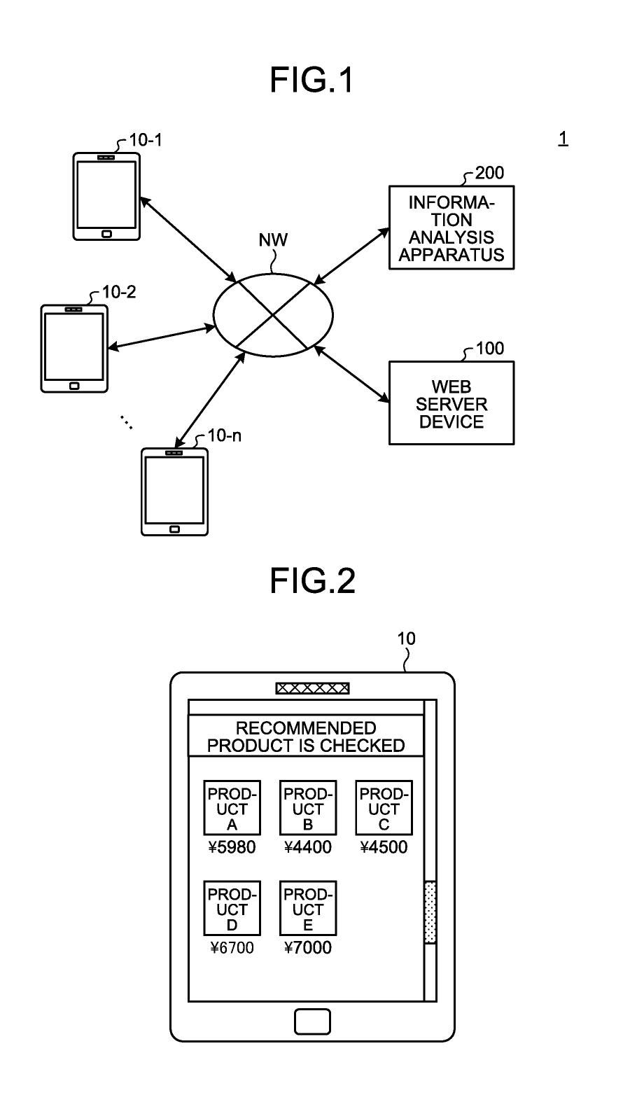

FIG. 1 illustrates an example of an information analysis system 1 including an information analysis apparatus 200 according to an embodiment. The information analysis system 1 in the embodiment includes a web server device 100 and the information analysis apparatus 200. At least the web server device 100 is connected to a plurality of terminal devices 10-1 to 10-n (n is an arbitrary natural number) via a network NW.

Each device shown in FIG. 1 transmits and receives various kinds of information via the network NW. The network NW includes, for example, a radio base station, a Wi-Fi access point, a communication line, a provider, the Internet, and the like. It is not necessary that all the combinations of the respective apparatuses shown in FIG. 1 can communicate with each other, and the network NW may partially include a local network.

Each of the plurality of terminal devices 10-1 to 10-n is a terminal device used by a user. Hereinafter, in the case where each of the plurality of terminal devices 10-1 to 10-n is not distinguished, they will be described while being simply referred to as the terminal device 10. The terminal device 10 is, for example, a mobile phone such as a smartphone, a tablet terminal, a PDA (Personal Digital Assistant), or a personal computer. The user operates the terminal device 10 and accesses the website provided by the web server device 100.

For example, UA such as a web browser is activated, and a predetermined operation is performed by the user, whereby the terminal device 10 transmits an HTTP (Hypertext Transfer Protocol) request to the web server device 100. Then, the terminal device 10 displays the web page on the display unit based on the HTTP response returned from the web server device 100. For data transmitted as an HTTP response includes, for example, text data described in a markup language such as HTML (Hyper Text Markup Language), a style sheet, still image data, moving image data, audio data and the like.

The web server device 100 is, for example, a server device that provides a sales site such as a shopping site, an auction site, a flea market site or the like. The web server device 100 posts a recommended item to a sales site provided by itself. This recommended item may be limited to an item handled in the sales site provided by the web server device 100 itself or may include an item handled in a web site provided by another web server device.

FIG. 2 is a diagram showing an example of a sales site displayed on the terminal device 10. As shown in FIG. 2, a plurality of recommended items (“recommended products” in the drawing) may be posted on the sales site.

The information analysis apparatus 200 evaluates the characteristic of the recommended item posted on the sales site by the web server device 100. Details will be described later.

Web Server Device

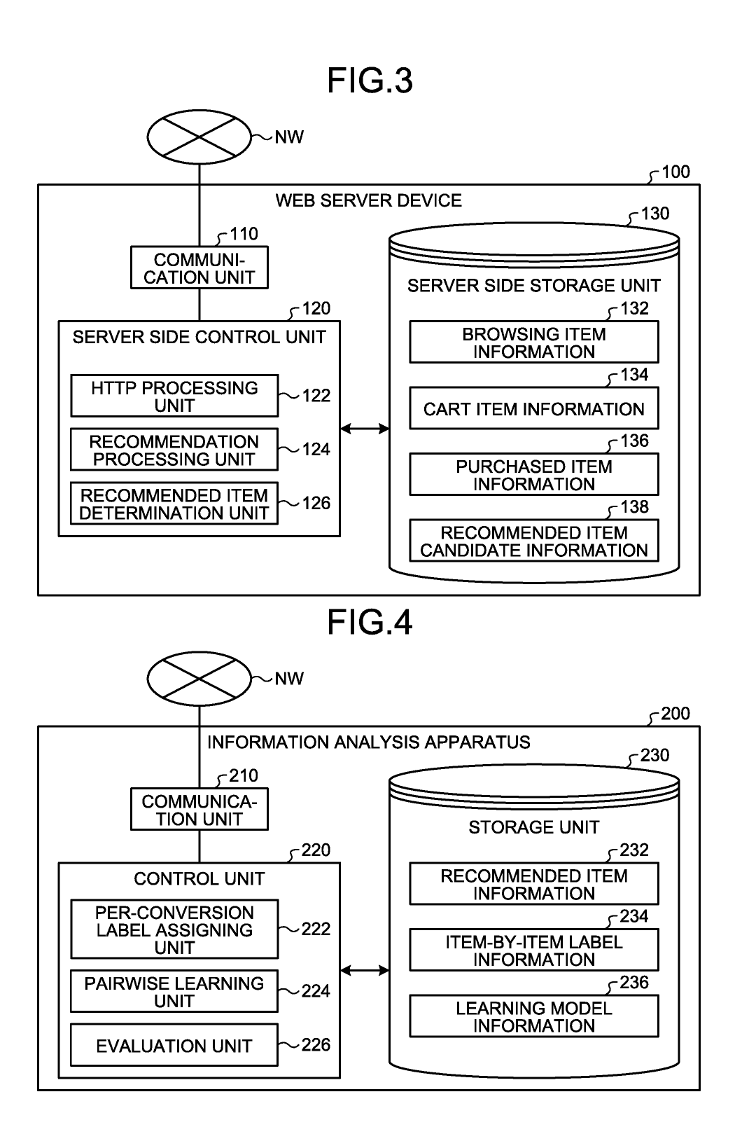

The respective configurations of the web server device 100 and the information analysis apparatus 200 will be described below. FIG. 3 illustrates an example of a web server device 100 according to the embodiment. As shown in FIG. 3, the web server device 100 includes, for example, a communication unit 110, a server side control unit 120, and a server side storage unit 130.

The communication unit 110 includes, for example, a communication interface such as NIC (Network Interface Card). The communication unit 110 communicates with the terminal device 10 and the information analysis apparatus 200 via the network NW. For example, the communication unit 110 receives an HTTP request from the terminal device 10. Further, the communication unit 110 may receive information on the browsing history of the web browser from the terminal device 10.

The server side control unit 120 includes, for example, an HTTP processing unit 122, a recommendation processing unit 124, and a recommended item determination unit 126. These components are implemented, for example, by a processor such as a CPU (Central Processing Unit) by executing a program stored in the server side storage unit 130. In addition, some or all of the components of the server side control unit 120 may be implemented by hardware (circuitry) such as a LSI (Large Scale Integration), an ASIC (Application Specific Integrated Circuit), or a FPGA (Field-Programmable Gate Array), and may be realized by cooperation of software and hardware.

When the HTTP request is received by the communication unit 110, the HTTP processing unit 122 reads data for generating a web page stored in advance in the server side storage unit 130, and using the communication unit 110, the HTTP processing unit 122 transmits the data read out to the transmission source of the HTTP request as an HTTP response.

In order to post a recommended item on a web page requested as an HTTP request before the HTTP processing unit 122 transmits an HTTP response, the recommendation processing unit 124 edits data transmitted as an HTTP response. For example, the recommendation processing unit 124 stores still image data, moving image data, audio data, and the like related to the recommended item in the data transmitted as an HTTP response. Further, the recommendation processing unit 124 may write a description designating the placement position and the font size of an image, a description, or the like indicating the recommended item of the web page on the text data or the style sheet to be transmitted together with these data, and may newly generate text data or style sheet in which these descriptions are written.

The recommended item determination unit 126 performs collaborative filtering based on browsing item information 132, a cart item information 134, and a purchased item information 136 to be described later, and determines the recommended item for each session. The collaborative filtering is processing of extracting, from preference information of a large number of users (132, 134, 136 etc. described above), preference information of other users similar in preference to the user who is recommended for the item, and guessing an item that matches the preference of the target user.

A session is a period of time from accessing a certain web page in the sales site to switching to another web page in the sales site or a web page in another website. In addition, the session may be a period from accessing a certain web page in the sales site to closing the web browser displaying the web page. In addition, the session may be a period from accessing a certain web page in the sales site until a predetermined time passes (timeout). The recommended item determination unit 126 may update the recommended item according to the change of the session.

Further, the recommended item determination unit 126 may determine priority (rank) of items to be adopted as a recommended item when assigning a collaborative filtering process, and may determine an item to be finally adopted as a recommended item after assigning a probability element such as a random number.

In addition, when information on the browsing history of the web browser in the terminal device 10 is acquired by the communication unit 110, the recommended item determination unit 126 may determine the recommended item by performing the collaborative filtering while further taking the information into consideration.

Also, the recommended item determination unit 126 may determine the placement order of items to be posted as recommended items based on the evaluation result by the information analysis apparatus 200. For example, when there is a limit on the number of recommended items that can be posted in the same sales site during one session, under this limitation, an item to be preferentially posted as a recommended item is selected from candidates of items indicated by recommended item candidate information 138 to be described later.

Also, the server side control unit 120 transmits, using the communication unit 110, information on items to be posted on the sales site as browsing item information 132, cart item information 134, purchased item information 136 to be described later, and recommended items, to the information analysis apparatus 200.

The server side storage unit 130 is realized by, for example, a HDD (Hard Disc Drive), a flash memory, an EEPROM (Electrically Erasable Programmable Read Only Memory), a ROM (Read Only Memory), a RAM (Random Access Memory), or a hybrid storage device combining a plurality of these. The server side storage unit 130 stores various programs such as firmware and application program, information received by the communication unit 110, and the like. In addition, the server side storage unit 130 stores the browsing item information 132, the cart item information 134, the purchased item information 136, and the recommended item candidate information 138.

The browsing item information 132 is information in which an item ID for identifying an item selected at the sales site is associated with each user ID for identifying a user. For example, the user ID may be a login ID of the sales site or a session ID managed by the web browser. The session ID is, for example, identification information that is written in a Cookie stored in a header of an HTTP response and is passed from the web server device 100 that manages the sales site to the web browser of the terminal device 10 This cookie may include information indicating the presence or absence of browsing of the item (for example, information on the browsing history of the web browser). The web browser of the terminal device 10 stores the cookie including the received session ID in the HTTP request, and transmits the HTTP request to the web server device 100. The HTTP processing unit 122 compares the session ID included in the HTTP request with the session ID included in the HTTP response, thereby identifying whether the session is the same session by the same user. As a result, the item ID of the selected item is associated with the user ID.

The cart item information 134 is information in which the item ID of an item to be purchased in a cart is associated with the user ID. The purchased item information 136 is information in which the item ID of the already purchased item is associated with the user ID. For example, the user ID in this case is the login ID of the sales site.

The recommended item candidate information 138 is information indicating a plurality of items that are candidate for recommended items. In the case where the item to be handled at the sales site provided by the web server device 100 is a recommended item, the web server device 100 may extract a plurality of items that are candidate for the recommended item from a part or all of the items handled at the sales site provided by the web server device 100. Furthermore, in the case where the item to be sold at the web site provided by another server device is a recommended item, the web server device 100 may extract a plurality of items that are candidate for the recommended item from a part or all of the items handled at another web site.

Information Analysis Apparatus

FIG. 4 illustrates an example of the information analysis apparatus 200 according to the embodiment. As shown in FIG. 4, the information analysis apparatus 200 includes, for example, a communication unit 210, a control unit 220, and a storage unit 230.

The communication unit 210 includes, for example, a communication interface such as NIC. The communication unit 210 communicates with the web server device 100 via the network NW. For example, the communication unit 210 receives, from the web server device 100, the above-described browsing item information 132, the cart item information 134, purchased item information 136, information on recommendation items posted on the sales site (information corresponding to the recommended item information 232).

The control unit 220 includes, for example, a per-conversion label assigning unit 222, a pairwise learning unit 224, and an evaluation unit 226. These constituent elements are realized, for example, by a processor such as a CPU executing a program stored in the storage unit 230. In addition, some or all of the components of the control unit 220 may be realized by hardware (circuitry) such as LSI, ASIC, FPGA, etc., or may be realized by cooperation of software and hardware.

The storage unit 230 is realized by, for example, an HDD, a flash memory, an EEPROM, a ROM (Read Only Memory), a RAM, or a hybrid type storage device combining a plurality of these. The storage unit 230 stores various programs such as firmware and application program, information received by the communication unit 210, and the like. In addition, the storage unit 230 stores recommended item information 232, item-by-item label information 234, and learning model information 236.

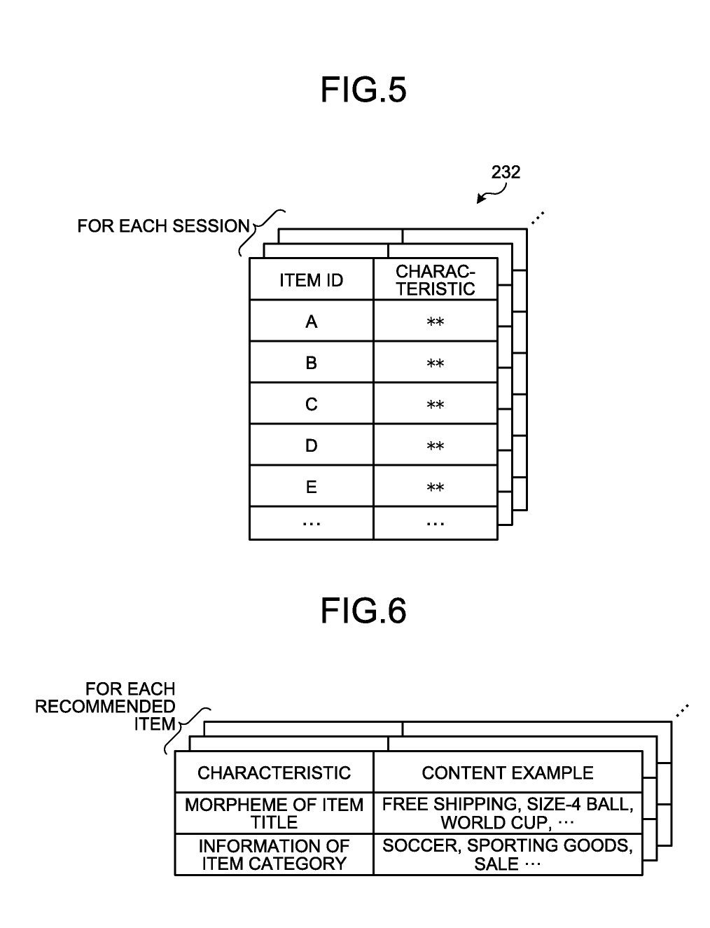

FIG. 5 illustrates an example of the recommended item information 232. The recommended item information 232 is information in which information on recommended item determined by the above-mentioned recommended item determination unit 126 is aggregated for each session. As shown in FIG. 5, the item ID of each recommended item is associated with a characteristic. The characteristic is a word representing an attribute such as a word (morpheme) included in an introduction text such as a title of a recommended item or a category of a recommended item. The morpheme is a word that has meaning in the introduction text of the recommended item.

FIG. 6 illustrates an example of a characteristic for each recommended item. For example, when the recommended item is “soccer ball” and the title is attached with a sentence such as “free shipping, soccer ball, World Cup official game ball, size-4”, the morpheme in this sentence becomes the characteristic on the recommended item. For example, nouns such as “free shipping”, “soccer”, “World Cup”, and “official game ball” can be cited as a morpheme. In addition, when the recommended item is classified into a category such as “soccer/sporting goods/sale”, a word representing this category is also the characteristic of the recommended item. The category may be set independently for each store at the sales site. In addition, the characteristic related to the recommended item may include an item ID (for example, product code) for each recommended item.

The per-conversion label assigning unit 222 determines whether various conversions are established based on the action of the user who has viewed the sales site during one session. The conversion means that a user who has selected the recommended item takes an action expected by a client who has requested the publication of the recommended item (for example, a site administrator or a store manager who raises revenue by the sales site). This action includes, for example, purchasing a recommended item after selection of the recommended item, purchasing an item different from the recommended item after selection of the recommended item at the sale site on which the recommended item is posted, (that is, purchasing some item different from the recommended item in the same sales site), and simply selecting a recommended item without purchasing an item (including the recommended item) in the sales site. Here, the selecting means an operation of the user clicking or tapping an area of the recommended item using the terminal device 10 and requesting the web server device 100 to transmit a web page relating to the recommended item.

For example, when a user purchases a recommended item, the per-conversion label assigning unit 222 determines that a first conversion has been established. In addition, the per-conversion label assigning unit 222 determines that a second conversion is established when the user purchases another item that is not the recommended item. In addition, the per-conversion label assigning unit 222 determines that the third conversion has been established when the user selects the recommended item and thereafter the session is switched without purchasing any item. Whether these conversions are successful or not is judged by referring to tracking information that can be included in cookie (HTTP cookie) managed by each web browser for each terminal device 10, information on Web Storage function, or the like.

Then, the per-conversion label assigning unit 222 assigns a label to the recommended item according to the presence or absence of the conversion and/or the type of the established conversion. A labels is represented by a numerical value, for example, and is treated as a weight (coefficients) in pairwise learning described below. The per-conversion label assigning unit 222 is an example of a “weight assigning unit”.

As the action of the user who has viewed the sales site is closer to the action expected by a client such as a site administrator, the per-conversion label assigning unit 222 assigns a label having a larger value to the recommended item. When a site administrator or the like expects improvement of profit by posting a recommended item, a label having the largest value is assigned to the action of purchasing the recommended item, and a label having a value larger than a label value assigned when the action is the action of purchasing the recommended item is assigned to the action of purchasing another item which is not a recommended item. A label having a value larger than the label value assigned when an action of purchasing another item is assigned to the action of simply selecting the recommended item without purchasing the item including the recommended item.

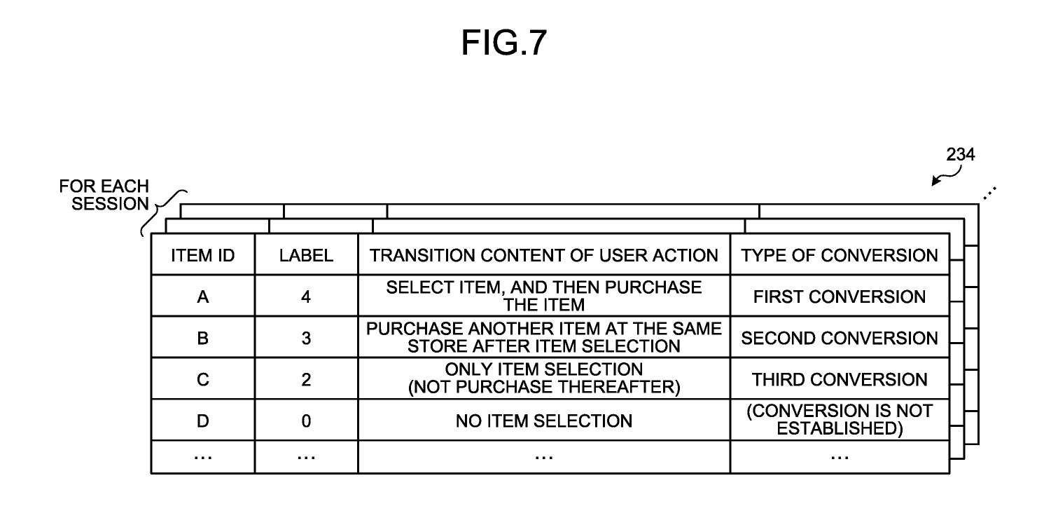

FIG. 7 illustrates an example of the item-by-item label information 234. As shown in FIG. 7, the item-by-item label information 234 is information in which information having labels that are associated with each item ID of recommended items is aggregated for each session. For example, when the user purchases the recommended item after selection of the recommended item (a first conversion is established), a label of “4” is assigned to the item ID indicating the recommended item. Also, when the user purchases an item different from the recommended item after selection of the recommended item on a sales site on which the recommended item is posted (for example, a web site of a shopping store handling the recommended item) (the second conversion is established), a label “3” is assigned to the item ID indicating the recommended item. In addition, although the purchase of the item has not been reached, when the user selects the recommended item at the sales site (third conversion is established), a label of “2” is assigned to the item ID indicating the recommended item. In addition, when the user does not take any of the above actions (the conversion is not established), a label of “0” is assigned to the item ID indicating the recommended item. These numerical values are merely examples, and any value may be used as long as the magnitude relationship according to the type of conversion (the degree of expectation for the user's action) is maintained.

The pairwise learning unit 224 derives the relevance between the characteristics corresponding to each of the plurality of recommended items to which the label is assigned, by pairwise learning. The pairwise learning in this embodiment is executed as a supervised learning that classifies target data into binary by treating the differential vector of the pair of two feature vectors as an index. The pairwise learning unit 224 is an example of a “selection unit”.

For example, in one session, the pairwise learning unit 224 selects two non-overlapping labels from the four labels associated with the conversion type, and pairs the two labels, in a combination of all labels. At this time, a pair in which the order of the two labels is exchanged with respect to the previously selected pair may be selected as a pair different from the previously selected pair. Thus, in the example of FIG. 7 described above, a total of twelve pairs, which is the result of the permutation of 4P2, is generated.

The pairwise learning unit 224 derives a distance between a feature vector and a boundary line of the dimension represented by a hyperplane HP for each of the plurality of feature vectors, in the feature space where the difference between the two labels in pairs is a feature vector (difference vector). The hyperplane HP is a subspace of the feature space, and is, for example, a space having a diminished dimension by 1 from the dimension number of the feature space. As shown in FIG. 7, when the feature space is expressed in two dimensions, the hyperplane HP is represented by a one-dimensional straight line. The boundary line of the dimension represented by this hyperplane HP may be determined by, for example, Ranking SVM (Support Vector Machine) which is one method of machine learning.

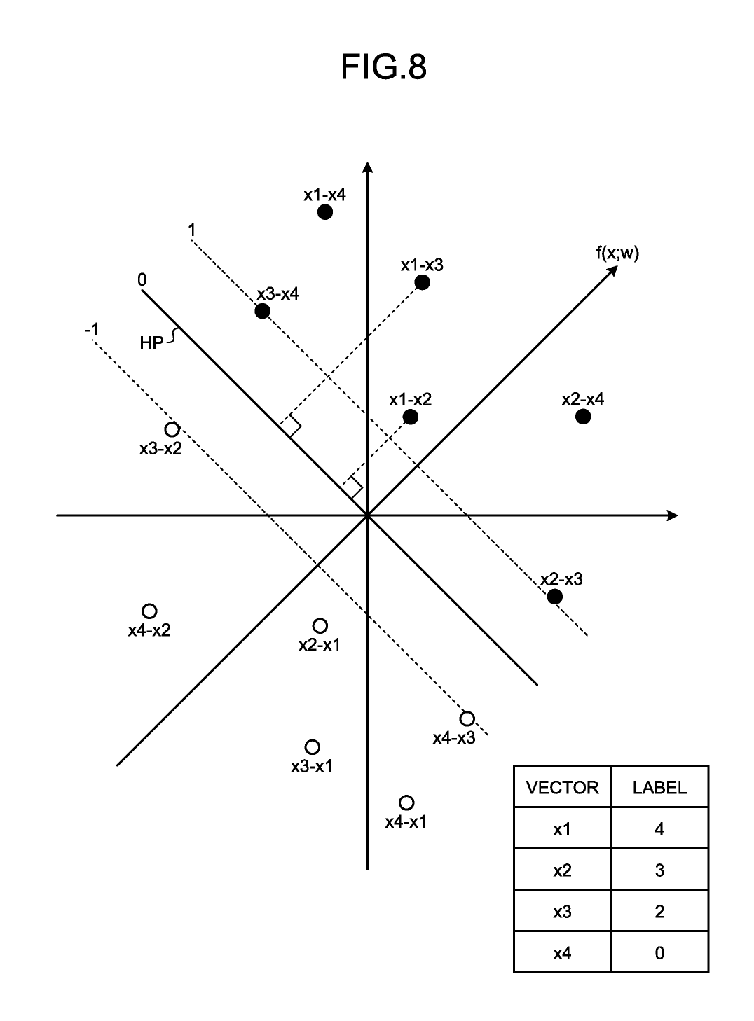

FIG. 8 illustrates an example of a feature space. The feature space may be converted into a space of degree k (k is an arbitrary natural number) using a kernel function. As illustrated, for example, when a vector corresponding to a label with a value of “4” is “x 1”, a vector corresponding to the label of the value of “3” is “x 2”, a vector corresponding to the label of the value of “2” is “x 3”, and a vector corresponding to a label having a value of “0” is “x 4”, a total of 12 points of feature vectors (x1-x2), (x1-x3), (x1-x4), . . . (x4-x1), (x4-x2), (x4-x3) are plotted in the feature space. For example, a feature vector (such as (x3-x4), (x2-x3), (x4-x3), and (x3-x2) in the example of FIG. 8) located near the boundary between the positive side and the negative side contributes to learning as a support vector. The pairwise learning unit 224 derives a straight line distance (length of a perpendicular line from each plotted point with respect to the boundary line) from a plot point indicating each feature vector to the boundary line represented by the hyperplane HP, for each feature vector plotted as a point.

Note that the pairwise learning unit 224 may change the boundary line indicating the hyperplane HP by learning, by using machine learning such as Ranking SVM described above such that the magnitude relation of the distance between the point indicating each feature vector and the boundary line tends to be the same as the magnitude relationship of the value indicating the feature vector (the difference of the label value). For example, the pairwise learning unit 224 may change the boundary line indicating the hyperplane HP by changing the parameters of the kernel function (such as the Radial Basis Function kernel). An equation modeling the boundary line indicating the hyperplane HP derived by the machine learning is stored in the storage unit 230 as the learning model information 236.

The evaluation unit 226 evaluates the relevance between the characteristics of the recommended item based on the distance to the hyperplane HP for each feature vector derived in the feature space by the pairwise learning unit 224.

Hereinafter, in order to describe the evaluation method, attention is paid only to the feature vector on the positive side; however, the negative side may also be evaluated in the same way as the positive side. Also, the characteristic of the recommended item corresponding to the label 4 is f4, the characteristic of the recommended item corresponding to the label 3 is f3, the characteristic of the recommended item corresponding to the label 2 is f2, and the characteristic of the recommended item corresponding to the label 0 is f0, and with this configuration, the evaluation method is described.

For example, when attention is paid to the feature vectors (x1-x2) and (x1-x3) in the above described FIG. 8, the evaluation unit 226 compares a distance from these points indicating the feature vectors to the hyperplane HP. As shown in FIG. 8, it is understood that a distance from the feature vector (x1-x2) to the hyperplane HP is shorter than the distance from the feature vector (x1-x3) to the hyperplane HP. Therefore, since xl is common, as compared with the characteristic f2 of the recommended item corresponding to x3 (that is, label 2), the evaluation unit 226 evaluates that the characteristic f3 of the recommended item corresponding to x2 (that is, label 3) has a greater degree of contribution to the action leading to the conversion though the type of the conversion is different. That is, in the evaluation, the larger the value of the ranking function f (x; w) represented by the straight line orthogonal to the boundary line indicating the hyperplane HP, the higher the contribution to the action leading to the conversion. From the relative evaluation result between such characteristics, the characteristic most contributing to purchase out of the characteristics of a plurality of recommended items to be compared can be specified. In other words, it is possible to identify the characteristic that can further enhance the purchase willingness of the user.

The evaluation unit 226 transmits the evaluation result described above, that is, the evaluation result of the degree of contribution for each characteristic with respect to the action leading to the conversion, for example, to the web server device 100 using the communication unit 210. For example, the evaluation result may be information arranged in descending order in ranking form from a highly evaluated characteristic. As a result, the recommended item determination unit 126 in the web server device 100 refers to the recommended item candidate information 138 and determines the order of priority when posting the item as the recommended item. For example, when there are a plurality of similar items of the same category as the recommended item candidates indicated by the recommended item candidate information 138, the recommended item determination unit 126 may compare the characteristics of respective items and sequentially determine the item in order from the item with the high evaluation value as the recommended item.

In addition, the evaluation unit 226 may transmit the evaluation result to a computer operated by a site administrator or a store manager of the sales site using the communication unit 210, and may output the evaluation result to a display device (not shown) of the information analysis apparatus 200 or the like. As a result, for example, the site administrator or the like can change the word to be added to the title of the item to be handled to a word with a higher evaluation (more easily purchased).

Processing Flow

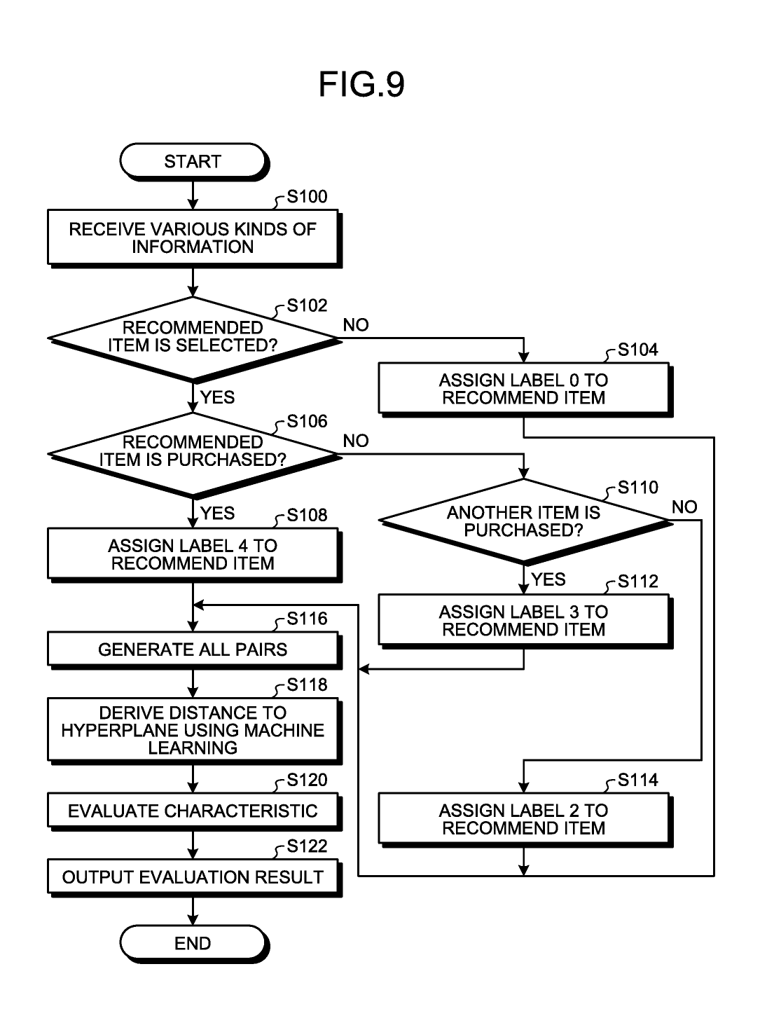

FIG. 9 illustrates an example of a flow of processing by the information analysis apparatus 200 according to the present embodiment. First, the communication unit 210 receives various kinds of information including the browsing item information 132, the cart item information 134, the purchased item information 136, and the recommended item information 232 from the web server device 100 (S100).

Next, the per-conversion label assigning unit 222 compares the browsing item information 132 and the recommended item information 232 and determines whether or not the recommend item is selected for each session (S102). If no recommended item is selected, the per-conversion label assigning unit 222 assigns the label 0 to the item ID of the recommend item (S104).

On the other hand, if the recommended item is selected, the per-conversion label assigning unit 222 determines whether or not the recommended item is purchased (S106). If the recommended item is purchased, the per-conversion label assigning unit 222 assigns the label 4 to the item ID of the recommended item (S108).

On the other hand, if the recommended item is not purchased, the per-conversion label assigning unit 222 determines whether or not another item that is not the recommended item is purchased (S110). If another item is purchased, the per-conversion label assigning unit 222 assigns the label 3 to the item ID of the recommended item (S112).

On the other hand, if another item is not purchased, the per-conversion label assigning unit 222 assigns the label 2 to the item ID of the recommended item (S114).

Next, the pairwise learning unit 224 generates a total of twelve pairs by solving the permutation problem of 4P2 by using the four types of labels assigned for each recommended item by the per-conversion label assigning unit 222 (S116).

Next, in the feature space with a difference between the labels of the 12 pairs as the feature vector, the pairwise learning unit 224 derives a distance between the feature vector and the boundary line of the dimension represented by the hyperplane HP for each of the plurality of feature vectors using Ranking SVM (S118).

Next, the evaluation unit 226 evaluates the relevance between the characteristics of the recommended item based on the distance to the hyperplane HP for each feature vector derived in the feature space by the pairwise learning unit 224 (S120).

Next, the evaluation unit 226 outputs the evaluation result to an external device or the like (S122). As a result, the processing of this flowchart ends.

Validation Example

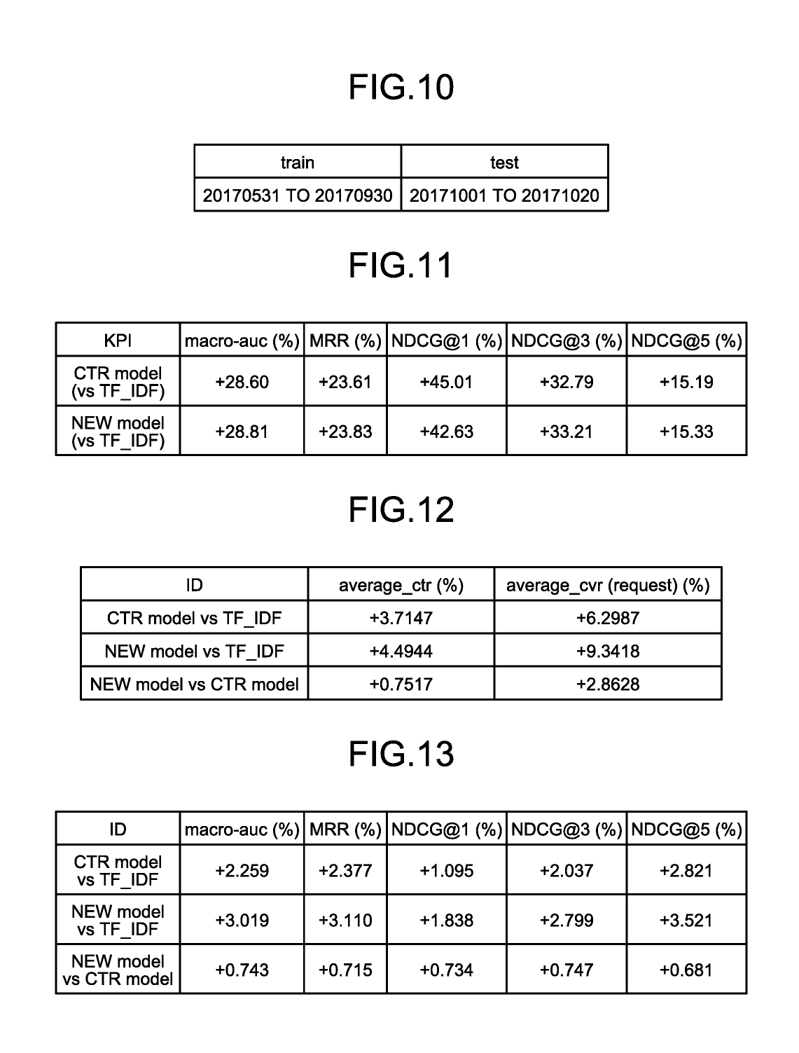

The applicant of the present application conducted a following experiment and verified an evaluation method proposed in this embodiment. FIG. 10 illustrates an example of acquisition period of data used for verification of the evaluation method. As shown in FIG. 10, for the verification, as training data for deriving the above-described function showing the hyperplane HP by pairwise learning, data (the browsing item information 132, cart item information 134, and purchased item information 136) in which information has been accumulated over four months was used. Also, data for four months different from the data used as training data was used as test data to be learned. As a result, the characteristic of recommended item of data used as test data is classified by a machine learning based on training data.

FIG. 11 illustrates an example of a verification result in an offline in which information is not accumulated in real time. As shown in the illustrated example, in this embodiment, the two methods were compared. One of the two methods is a machine learning method (CTR-model) for modeling a boundary line showing a hyperplane HP using a CTR as a function, and the other is a machine learning method Method (NEW-model). These two methods were verified by comparing them with TF-IDF method.

The technique using the CTR, which is the conventional technique, is a method of performing machine learning using the determination result as to whether or not the third conversion is established among the conversions in the present embodiment. Only the vector of difference between the label 2 and the label 0 is taken as a feature vector. Also, the TF-IDF method performs evaluation based on two indexes of a word appearance frequency TF (Term Frequency) obtained by dividing the number of occurrences of a word of interest appearing in one document by the sum of appearance frequencies of all words appearing in one document, and an inverse document frequency IDF (Inverse Document Frequency) obtained by dividing the total number of documents in the data by the number of documents containing the target word.

The evaluation index used for verification as KPI (Key Performance Indicator) is, for example, macro-auc (%), MRR (Mean Reciprocal Rank) (%), and a plurality of NDOCs (Normalized Discounted Cumulated Gain) with different maximum number ranking (%). The macro-auc is an index represented by the area under the curve on the ROC (Receiver Operating Characteristic) curve showing the correlation between the correct data and the error data. The correct data and the error data may be acquired by classifying the test data into binary according to the boundary line of the hyperplane HP derived by the training data. For example, macro-auc is 100% if the test data can be completely classified into the correct data and error data, and is 50% if the test data is randomly classified. MRR is an evaluation index obtained by, while attention is paid to the reciprocal of the ranking, calculating the reciprocal of the order of the correct data when the correct data first appears (rank indicating the order in which the correct answer data has appeared from the first data (RR (Reciprocal Rank)), and averaging the reciprocal of the order of all correct data. For example, MRR becomes 0 if no correct data appears. NDOC is an index indicating the correctness of the ranking proposed by machine learning and a value thereof is normalized so that the value in the case where perfectly correct ranking is made is 100%. The larger the value of NDOC, the better the evaluation. In the present embodiment, NDOG@1 which evaluates the accuracy of the highest ranking, NDOG@3 which evaluates the correctness of the top three rankings, and NDOG@5 which evaluates the accuracy of the top 5 rankings are used to perform evaluation. As shown in FIG. 11, the evaluation value in the method of this embodiment was larger in the other evaluation indexes except for NDOG@1 than the method using the conventional CTR.

In addition, the applicant of the present application verified real-time evaluation by transmitting the training data at any time from the web server device 100 to the information analysis apparatus 200 by a live test format. FIG. 12 illustrates an example of a verification result in an online in which information is accumulated in real time. As shown in FIG. 12, compared to a conventional CTR method, the method of this embodiment was larger in both index-value value of average-ctr (%) indicating the average of CTR and average-cvr (%) indicating average of CVR (Conversion Rate). In other words, it can be evaluated that the method according to the present embodiment improves the number of selections (number of views) of recommended items and the number of purchase of recommended items.

FIG. 13 illustrates another example of a verification result in an online in which information is accumulated in real time. Each evaluation index (KPI) shown in FIG. 13 is the same as the evaluation index shown in FIG. 11 described above. As shown in FIG. 13, the evaluation value in the method of this embodiment is larger in all the evaluation indexes than in the method using the conventional CTR.

Based on the above evaluation results, it is possible to evaluate that in this method, there is posted a recommended item that a user is more interested to than in the conventional method, on the sales site. That is, it can be evaluated that the user's purchase willingness is increased.

According to the above-described embodiment, based on the action taken by the user who has viewed the sales content on which a plurality of recommended items are posted, by assigning a weight to each of a plurality of recommended items, selecting a plurality of pairs associating two items from a plurality of recommended items, and evaluating the characteristic based on characteristic information indicating the property of each of the two items selected as a pair and the weight assigned to the two items, it is possible to generate information for recommending an item with high interest of the user.

It is to be noted that although the above-described terminal device 10 has been described as providing the sales site by the web browser as the sales content, the present invention is not limited to this. For example, an application screen corresponding to the sales site may be provided by a previously installed application program. In this case, the web server device 100 may be an application server cooperating with the application program installed in the terminal device 10.

Further, the evaluation unit 226 in the information analysis apparatus 200 described above may determine a feature vector to be evaluated from a plurality of feature vectors in the feature space according to the attribute of the user. The attribute may be, for example, sex, age, occupation, but is not limited thereto. For example, the evaluation unit 226 extracts only the feature vector labeled based on the action (conversion) taken by the user matching the attribute such as a man under 30 years old from the feature space, and evaluates the relevance between the characteristics extracted from these extracted feature vectors. In this way, it is possible to post a recommended item which can attract a particular user's interest particularly to the sales site.

In addition, one or both of the recommendation processing unit 124 and the recommended item determination unit 126 in the above-described web server device 100 may be included in the control unit 220 of the information analysis apparatus 200.

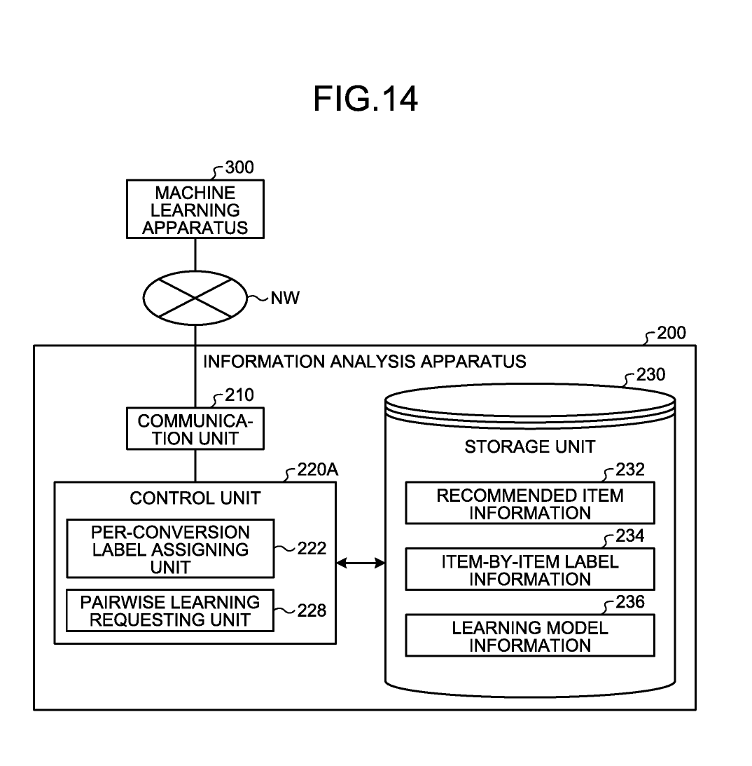

Further, some or all of the functions of the pairwise learning unit 224 in the information analysis apparatus 200 and the evaluation unit 226 may be provided by other analysis apparatuses. FIG. 14 illustrates an example of the information analysis apparatus 200 and a machine learning apparatus 300 which is another analysis apparatus. The machine learning apparatus 300 is, for example, a computer that performs parallel calculation using a GPU (Graphics Processing Unit) or the like. A control unit 220A in the information analysis apparatus 200 according to the modification example includes, for example, the above-described per-conversion label assigning unit 222 and a pairwise learning requesting unit 228. The pairwise learning requesting unit 228 is an example of an “output unit”. The pairwise learning requesting unit 228 obtains the difference between the two labels that are paired, and outputs information (difference vector) indicating a label difference to the machine learning apparatus 300, thereby requesting the machine learning apparatus 300 to perform pairwise learning. The machine learning apparatus 300 performs pairwise learning based on the difference between labels output by the information analysis apparatus 200 and evaluates the characteristic of the recommended item. Then, the machine learning apparatus 300 outputs the evaluation information indicating the evaluation result of the characteristic, to the information analysis apparatus 200. The pairwise learning requesting unit 228 of the information analysis apparatus 200 transmits the evaluation information acquired from the machine learning apparatus 300 to the web server device 100 or the like. At this time, the pairwise learning requesting unit 228 may process the evaluation information acquired from the machine learning apparatus 300 into data or the like expressed in the ranking form. As a result, similarly to the above-described embodiment, it is possible to generate information for recommending an item with high interest of the user.

Hardware Configuration

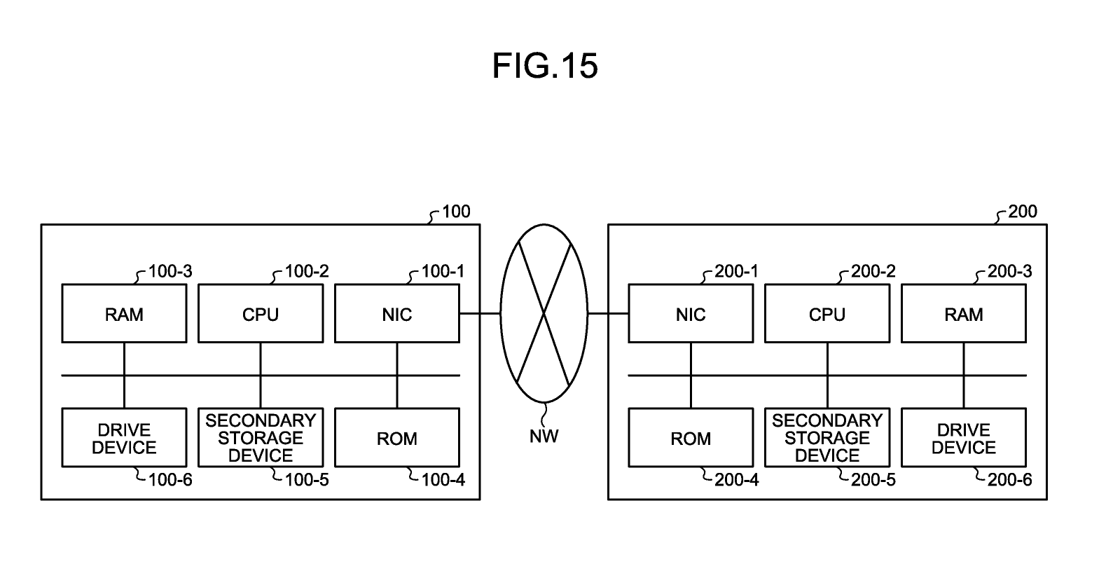

The web server device 100 and the information analysis apparatus 200 of the embodiment described above are realized by a hardware configuration as shown in FIG. 15, for example. FIG. 15 illustrates an example of a hardware configuration of the web server device 100 and the information analysis apparatus 200 according to the embodiment.

The web server device 100 has a structure in which a NIC 100-1, a CPU 100-2, a RAM 100-3, a ROM 100-4, a secondary storage device 100-5 such as a flash memory and HDD, and a drive device 100-6 are mutually connected by an internal bus or a dedicated communication line. A portable storage medium such as an optical disk is mounted on the drive device 100-6. The advertisement moving image management program stored in the portable storage medium attached to the secondary storage device 100-5 or the drive device 100-6 is developed in the RAM 100-3 by a DMA controller (not shown) or the like, and executed by the CPU 100-2, thereby realizing the server side control unit 120. The program referred to by the server side control unit 120 may be downloaded from another device via the network NW.

The information analysis apparatus 200 has a structure in which a NIC 200-1, a CPU 200-2, a RAM 200-3, a ROM 200-4, a secondary storage device 200-5 such as a flash memory and HDD, and a drive device 200-6 are mutually connected by an internal bus or a dedicated communication line. A portable storage medium such as an optical disk is attached to the drive device 200-6. The advertisement moving image management program stored in the portable storage medium attached to the secondary storage device 200-5 or the drive device 200-6 is developed in the RAM 200-3 by a DMA controller (not shown) or the like, and executed by the CPU 200-2, thereby realizing the control unit 220. The program referred to by the control unit 220 may be downloaded from another device via the network NW.

According to an aspect of the present invention, it is possible to generate information for recommending an item with high interest of the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information analysis apparatus comprising:
a weight assigning unit that assigns a weight to each of a plurality of items based on an action taken by a user who has viewed a sales content on which the plurality of items to be recommended are posted;
a selection unit that selects a plurality of pairs in which two items are selected among the plurality of items placed in the sales content and associated with each other; and
an evaluation unit that evaluates a characteristic based on characteristic information indicating a property of each of the two items selected as a pair by the selection unit and the weight assigned by the weight assigning unit to the two items.

2. The information analysis apparatus according to claim 1, wherein the characteristic includes at least one of a word included in an introduction text displayed when the item is posted on the sales content and attribute information previously assigned to the item.

3. The information analysis apparatus according to claim 1, wherein the weight assigning unit determines a magnitude of the weight based on a type of action taken by a user who has viewed the sales content.

4. The information analysis apparatus according to claim 3, wherein the weight assigning unit assigns the largest weight to a purchased item when an action of purchasing the item is taken by a user who has browsed the sales content.

5. The information analysis apparatus according to claim 1, wherein the evaluation unit learns a relationship between a disparity in the feature and the weight based on a difference in weight assigned to each of the two items, to evaluate a characteristic corresponding to each of the plurality of items.

6. The information analysis apparatus according to claim 1, further comprising a determination unit that determines a priority order for posting the plurality of items in the sales content based on an evaluation result evaluated by the evaluation unit.

7. An information analysis apparatus comprising:
a weight assigning unit that assigns a weight to each of a plurality of items based on an action taken by a user who has viewed a sales content on which the plurality of items to be recommended are posted;
a selection unit that selects a plurality of pairs in which two items are selected among the plurality of items placed in the sales content and associated with each other; and
an output unit that acquires evaluation information for which the characteristic has been evaluated, from an external device, and outputs information based on the evaluation information based on characteristic information indicating a property of each of the two items selected as a pair by the selection unit and the weight assigned by the weight assigning unit to the two items.

8. An information analysis method allowing a computer to:
assigning a weight to each of a plurality of items based on an action taken by a user who has viewed a sales content on which the plurality of items to be recommended are posted;
selecting a plurality of pairs in which two items are selected among the plurality of items placed in the sales content and associated with each other; and
evaluating a characteristic based on characteristic information indicating a property of each of the two items selected as the pair and the weight assigned to the two items.

9. A non-transitory computer readable storage medium having stored therein an information analysis program causing a computer to:
assigning a weight to each of a plurality of items based on an action taken by a user who has viewed a sales content on which the plurality of items to be recommended are posted;
selecting a plurality of pairs in which two items are selected among the plurality of items placed in the sales content and associated with each other; and
evaluating a characteristic based on characteristic information indicating a property of each of the two items selected as the pair and the weight assigned to the two items.
